(19) United States
(12) Patent Application Publication
(10) Pub. No.: US 2018/0355899 A1
(43) Pub. Date: Dec. 13, 2018

(54) THUMB SCREW CONNECTING STRUCTURE, TABLE AND CHAIR

(71) Applicant: Zhejiang Yotrio Group Co., Ltd., Linhai (CN)

(72) Inventors: Wenjie ZHANG, Linhai (CN); Jianping XIE, Linhai (CN)

(73) Assignee: Zhejiang Yotrio Group Co., Ltd., Linhai (CN)

(21) Appl. No.: 15/871,893

(22) Filed: Jan. 15, 2018

(30) Foreign Application Priority Data
Jun. 9, 2017 (CN) 201720672780.3

(51) Int. Cl. F16B 12/14; F16B 35/00; A47C 4/02; A47B 3/06

(52) U.S. Cl. CPC F16B 12/14; A47B 3/06; A47C 4/02; F16B 35/00

(57) ABSTRACT

This invention provides a thumb screw connecting structure, including a thumb screw, a first stopper, and a second stopper, the first stopper and the second stopper are fixedly connected via the thumb screw; and a protruding fixing portion is disposed at the second stopper, an internal thread fitting the thumb screw is disposed inside the protruding fixing portion, and the protruding fixing portion is used to fix the thumb screw. The thumb screw connecting structure is convenient and efficient in use, the first stopper and the second stopper can be fixed without using a wrench or other tools, which is convenient as well as practical. This invention further provides a table and a chair, and the table and the chair are fixed by adopting the thumb screw connecting structures, which is convenient and practical when assembling and disassembling.

### CROSS-REFERENCE TO RELATED APPLICATIONS

This Non-provisional application claims priority under 35 U.S.C. § 119(a) on Patent Application No(s). 201720672780.3 filed in People's Republic of China on Jun. 9, 2017, the entire contents of which are hereby incorporated by reference.

### BACKGROUND OF THE INVENTION

### Field of the Invention

This invention relates to a connecting fixing element and application thereof, and more particularly, to a thumb screw connecting structure, a chair and a table.

### Description of the Related Art

At present, with the improvement of living standard, more and more household products are chosen to be custom-made or assembled. However, most assembly products are inconvenient when assembling, for example, screws need a wrench to be screwed and fixed. When screws are used to fix a table or a chair, the assembling becomes very inconvenient as the connecting structures of the table and the chair are inconvenient.

### BRIEF SUMMARY OF THE INVENTION

To solve the deficiency of being inconvenient in assembly in the prior art, this invention provides a thumb screw connecting structure, a chair and a table.

To solve the technical problems above, this invention provides a following technical solution:

a thumb screw connecting structure includes a thumb screw, a first stopper, and a second stopper, and the first stopper and the second stopper are fixedly connected via the thumb screw; and

a protruding fixing portion is disposed at the second stopper, an internal thread fitting the thumb screw is disposed inside the protruding fixing portion, and the protruding fixing portion is used to fix the thumb screw.

As an implementable way, the thumb screw may include a screw head and a screw section connected with the screw head, the screw head may include a screw head main body and at least two screwing portions, and the screw head main body may be fixedly connected with each screwing portions; and

the screwing portion may include a first connector and a second connector, a surface of the first connector and a surface of the second connector may be provided with friction portions, respectively, the first connector may be fixedly connected with the second connector, and the surface of the first connector and the surface of the second connector may be smoothly connected and may form an angle.

As an implementable way, the friction portions may fully cover the surface of the first connector and the surface of the second connector, respectively.

As an implementable way, the screw head may be a plastic screw head.

A chair: includes a supporting frame, a left armrest, a right armrest, a backrest, a base plate and thumb screw connecting structures of any of claims 1-4; and

the base plate is connected with the supporting frame via a plurality of thumb screw connecting structures, the left armrest and the right armrest are located at two sides of the supporting frame, respectively, and the backrest is located between the left armrest and the right armrest and connected with the supporting frame.

As an implementable way, a second surrounding edge and a third surrounding edge may be disposed at the supporting frame, the first surrounding edge, the second surrounding edge and the third surrounding edge may serve as the first stopper, respectively, the base plate and the edges corresponding to the first surrounding edge, the second surrounding edge and the third surrounding edge may serve as the second stopper, and the base plate and the supporting frame may be fixedly connected via the thumb screw of the thumb screw connecting structure.

A table: includes a table top, table legs and thumb screw connecting structures of any of claims 1-4; and

supporting portions with a number corresponding to the table legs are disposed below the table top, and the supporting portions and the table legs are fixed via a plurality of thumb screw connecting structures.

As an implementable way, the table may further include fixing frames, and the number of edges of the fixing frames may be equal to the number of the table legs; and

a chamfer may be disposed at a joint of two edges of the fixing frame, and an edge with the chamfer and the table leg may be fixed via a plurality of thumb screw connecting structures.

As an implementable way, the supporting portion may serve as the second stopper, a beam may be disposed at a top of the table leg, the beam may serve as the first stopper, and the table top and the table legs may be fixed via the thumb screws of the thumb screw connecting structures.

As an implementable way, the edge of the fixing frame with the chamfer may serve as the first stopper, the table leg may serve as the second stopper, and the table legs and the fixing frame may be fixedly connected via the thumb screws of the thumb screw connecting structures.

This invention has significant technical effects as it adopts the above technical solution:

this invention is a thumb screw connecting structure, including a thumb screw, a first stopper, and a second stopper, the first stopper and the second stopper are fixedly connected via the thumb screw; and

a protruding fixing portion is disposed at the second stopper, an internal thread fitting the thumb screw is disposed inside the protruding fixing portion, and the protruding fixing portion is used to fix the thumb screw. The thumb screw connecting structure is convenient and efficient when using, the first stopper and the second stopper can be fixed without using a wrench or other tools, which is convenient as well as practical.

This invention further provides a table and a chair, the table and the chair are fixed with thumb screw connecting structures, which is convenient and practical when assembling and disassembling.

### BRIEF DESCRIPTION OF THE DRAWINGS

To describe the technical solution of the embodiments in the invention and the prior art more clearly and completely, figures for the embodiments in the invention and the prior art are briefly introduced below. Obviously that the following figures are only some embodiments of the invention, for one skilled in the art, without creative work, other figures can be obtained according to these figures.

FIG. 1 is an overall structural schematic diagram of a thumb screw connecting structure of the invention;

FIG. 2 is an overall side view of FIG. 1;

FIG. 3 is a structural schematic diagram of a thumb screw of FIG. 1;

FIG. 4 is a top view of FIG. 3;

FIG. 5 is an overall structural schematic diagram of a chair;

FIG. 6 is a top view of a chair;

FIG. 7 is an overall structural schematic diagram of a table;

FIG. 8 is an enlarged view of A of FIG. 7; and

FIG. 9 is an enlarged view of B of FIG. 7.

### DETAILED DESCRIPTION OF THE INVENTION

In view of the following embodiments, the technical solution of the invention is described in a manner sufficiently clear and complete. The following embodiments are explanations of the invention, and the invention is not limited to the following embodiments.

An exemplary structure:

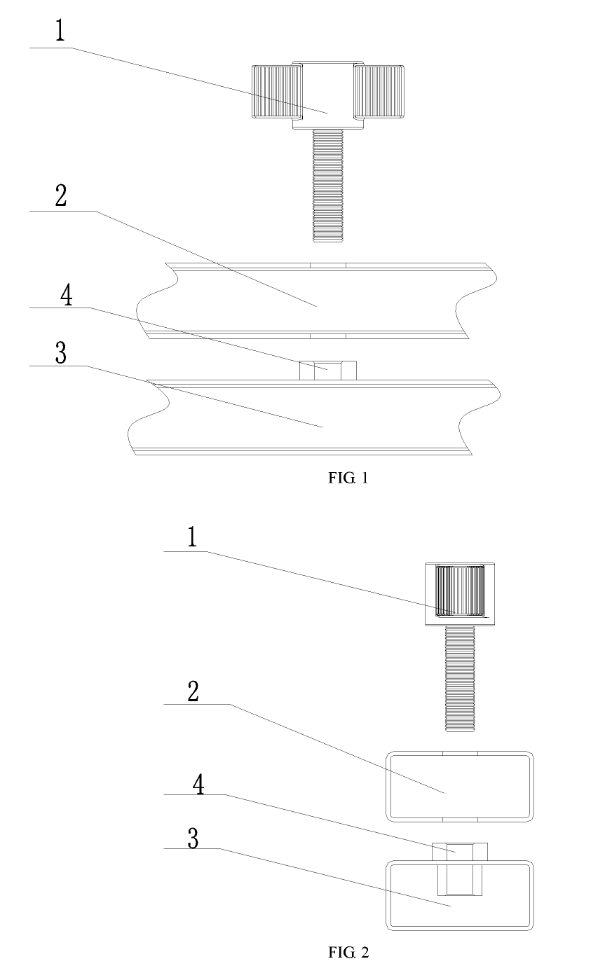

This invention provides a thumb screw connecting structure, as shown in FIG. 1 and FIG. 2, it includes a thumb screw 1, a first stopper 2, and a second stopper 3, and the first stopper 2 and the second stopper 3 are fixedly connected via the thumb screw 1; and

a protruding fixing portion 4 is disposed at the second stopper 3, an internal thread fitting the thumb screw 1 is disposed inside the protruding fixing portion 4, and the protruding fixing portion 4 is used to fix the thumb screw 1. The thumb screw connecting structure is convenient and efficient when using, and the first stopper 2 and the second stopper 3 can be fixed without using a wrench or other tools, which is convenient as well as practical.

### Embodiment 1

This invention provides a thumb screw connecting structure, as shown in FIG. 1 and FIG. 2, it includes a thumb screw 1, a first stopper 2, and a second stopper 3, and the first stopper 2 and the second stopper 3 are fixedly connected via the thumb screw 1; and

a protruding fixing portion 4 is disposed at the second stopper 3, an internal thread fitting the thumb screw 1 is disposed inside the protruding fixing portion 4, and the protruding fixing portion 4 is used to fix the thumb screw 1. In this embodiment, one end of the protruding fixing portion 4 is extended to the inside of the second stopper 3, the other end is at the outside of the second stopper 3, and such structure has a better fixing effect. The protruding fixing portion 4 and the second stopper 3 can be welded, or molded to form one body. In this embodiment, it should be noted that both the first stopper 2 and the second stopper 3 are tubular structures. When the first stopper 2 is a tubular structure, only opening a through-hole matching with the thumb screw 1 at the second stopper 3 can traverse the first stopper 2. Open a hole or a through-hole at the second stopper 3, then the thumb screw 1 is able to traverse the hole or through-hole of the second stopper 3 after traversing the first stopper 2, and the first stopper 2 and the second stopper 3 are connected. To get a former connection, a protruding fixing portion 4 is disposed at the second stopper 3, and an internal thread fitting the thumb screw 1 is disposed inside the protruding fixing portion 4. In this way, the thumb screw 1 is able to traverse the hole or through-hole of the second stopper 3 after traversing the protruding fixing portion 4 after traversing the first stopper 2, then the first stopper 2 and the second stopper 3 are fixed more firmly.

In other embodiments, the first stopper 2 and the second stopper 3 can be solid constructions. At this time, a screw hole is disposed at the first stopper 2 for the thumb screw 1 to traverse, and this screw hole is a through-hole. A first screw hole is also disposed at the second stopper 3 for the thumb screw 1 to traverse, and this first screw hole can be either a through-hole or not a through-hole, in this way, the thumb screw 1 can directly traverse the screw hole and then pass the first screw hole to fixedly connect the first stopper 2 and the second stopper 3.

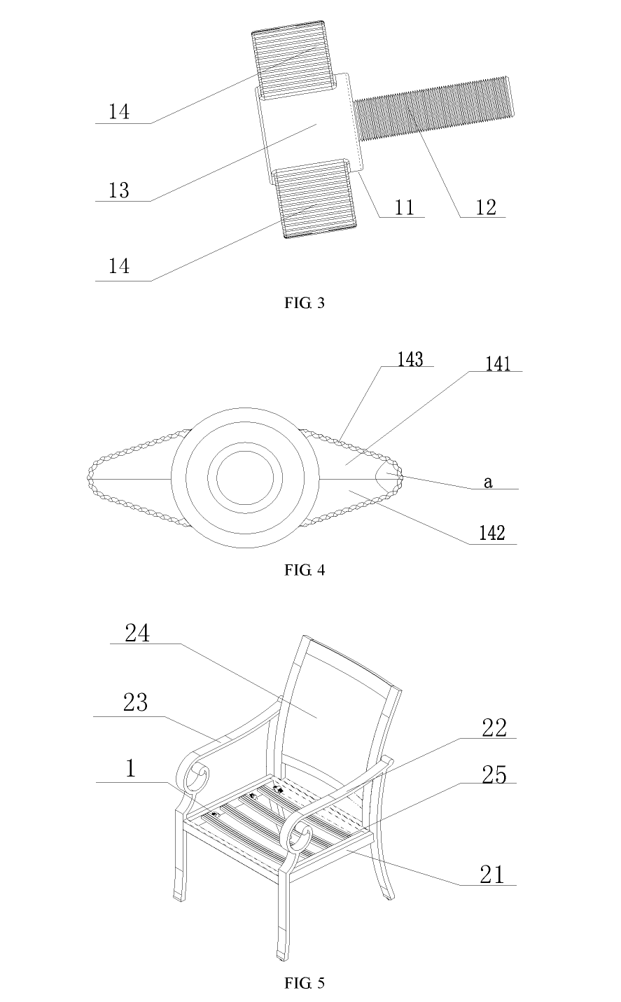

More specifically, as shown in FIG. 3 and FIG. 4, the thumb screw 1 includes a screw head 11 and a screw section 12 connecting with the screw head 11, the screw head 11 includes a screw head main body 13 and at least two screwing portions 14, and the screw head main body 13 is fixedly connected with each screwing portions 14; and

the screwing portion 14 includes a first connector 141 and a second connector 142, a surface of the first connector 141 and a surface of the second connector 142 are provided with friction portions 143, respectively, the first connector 141 is fixedly connected with the second connector 142, and the surface of the first connector 141 and the surface of the second connector 142 are smoothly connected and form an angle a. In this embodiment, the angle a is 10°-90° . Note that the center line in FIG. 4 is an auxiliary line. It is not a line for the invention, but is drawn to better describe the structure between the first connector 141 and the second connector 142.

In this embodiment, the screw head 11 is a plastic screw head. In other embodiments, the screw head 11 can be a metal screw head or a screw head made in other materials.

Note that figures in this invention show two screwing portions 14, and the two screwing portions 14 are designed along the center line of the screw head main body 13. However, in practical application, a plurality of screwing portions 14 can be adopted, for example 3, 4, or more. At this time, the location of the screwing portions 14 need not to be limited, and the screwing can be easily achieved and other structures can be successfully connected; and such structures of the thumb screw 1 are more convenient for screwing by hand, easily fixing the other two structures needed to be fixed without using any other tools.

To achieve a better convenience in practical application, the friction portions 143 fully cover the surface of the first connector 141 and the surface of the second connector 142, respectively.

Of course, in other embodiments, it is also available with the friction portions 143 not fully covering the surface of the first connector 141 and the surface of the second connector 142, while the effect is not as well as fully covering the surface of the first connector 141 and the surface of the second connector142.

### Embodiment 2

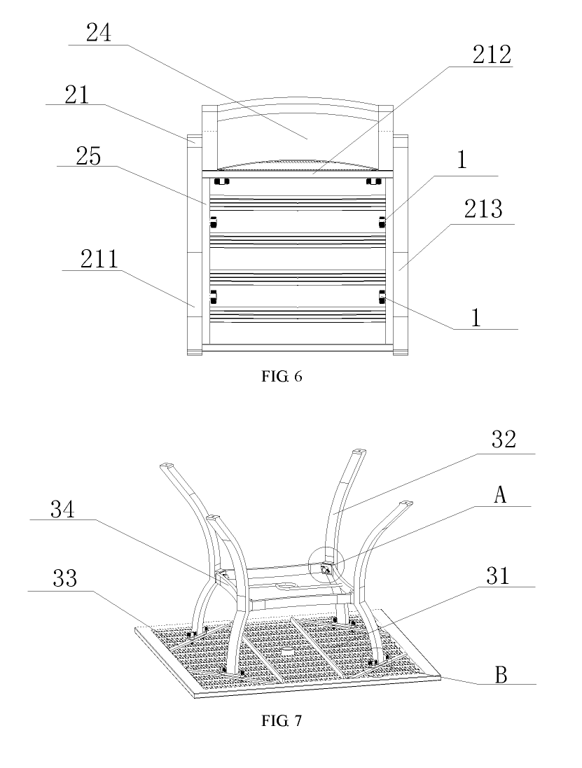

Embodiment 2 is an application of the thumb screw connecting structure of this invention, and the thumb screw connecting structure will be applied in a chair. Schematic diagrams of the chair are shown in FIG. 5 and FIG. 6, and the chair includes a supporting frame 21, a left armrest 22, a right armrest 23, a backrest 24, a base plate 25 and thumb screw connecting structures.

The base plate 25 is connected with the supporting frame 21 via a plurality of thumb screw connecting structures, the left armrest 22 and the right armrest 23 are located at two sides of the supporting frame 21, respectively, and the backrest 24 is located between the left armrest 22 and the right armrest 23 and connected to the supporting frame 21.

Note that the left armrest 22 and the right armrest 23 are integrally designed with the supporting frame 21, while the backrest 24 and the supporting frame 21 are also integrally designed. However, there are no connections between the left armrest 22 and the backrest 24, and the right armrest 23 and the backrest 24.

Further, a first surrounding edge 211, a second surrounding edge 212 and a third surrounding edge 213 are disposed at the supporting frame 21, and the first surrounding edge 211, the second surrounding edge 212 and the third surrounding edge 213 serve as the first stopper, respectively. That is, the three surrounding edges of the supporting frame serve as the first stopper of the thumb screw connecting structure. The base plate 25 and the edges corresponding to the first surrounding edge 211, the second surrounding edge 212 and the third surrounding edge 213 serve as the second stopper and the edges corresponding to the three surrounding edges on the base plate 25 serve as the second stopper. Note that the first surrounding edge 211, the second surrounding edge 212 and the third surrounding edge 213 of the supporting frame 21 are hollow structures, and the base plate 25 and the edges corresponding to the three surrounding edges are also tubular structures. At this time, through-holes matching with the thumb screw 1 are disposed at the first surrounding edge 211, the second surrounding edge 212 and the third surrounding edge 213, respectively. Holes are disposed at the base plate 25 and the edges corresponding to the first surrounding edge 211, the second surrounding edge 212 and the third surrounding edge 213, and a protruding fixing portion 4 is disposed. The thumb screw 1 traverses the through-hole the protruding fixing portion, and the first hole to fixedly connect the three surrounding edges and the corresponding three edges.

### Embodiment 3

Embodiment 3 is an application of the thumb screw connecting structure of this invention, and the thumb screw connecting structure is applied in a table. The schematic diagram of the table is shown in FIG. 7, and the table includes a table top 31, table legs 32 and thumb screw connecting structures; and

supporting portions 33 with the number corresponding to the table legs 32 are disposed below the table top 31, and the supporting portions 33 are used to provide a connection for the table legs 32 and the table top 31 and to support knitting fabric of the table top 31. In this embodiment, taking the number of the table legs is 4 as an example, four supporting portions 33 are adopted, and the supporting portions 33 are connected with the neighboring two edges of the table top 31, respectively. The supporting portions 33 and the table legs 32 are fixed via a plurality of thumb screw connecting structures.

The table further includes fixing frames 34, in this embodiment, the fixing frame 34 is actually a frame, and each edges of the frame is a tubular structure. Of course, in other embodiments, solid structure is also available, the number of edges of the fixing frames 34 is equal to that of the table legs 32. As shown in FIG. 8, a chamfer are disposed at a joint of two edges of the fixing frame 34, and an edge with the chamfer 35 and the table leg 32 are fixed via a plurality of thumb screw connecting structures. Note that for a better fixing effect of the fixing frames 34, a rail is disposed in the middle of the fixing frames 34, and the rail is disposed at two opposite edges of the fixing frames 34.

As the second stopper, the supporting portion 33 must be provided with a protruding fixing portion. A beam 321 is disposed at the top of the table leg 32 and the beam 321 serves as the first stopper. The table top 31 and the table legs 32 are fixed via the thumb screws 1 of the thumb screw connecting structures, that is, a whole thumb screw connecting structure is completed by the supporting portion 33, the beam 321, and the thumb screw 1.

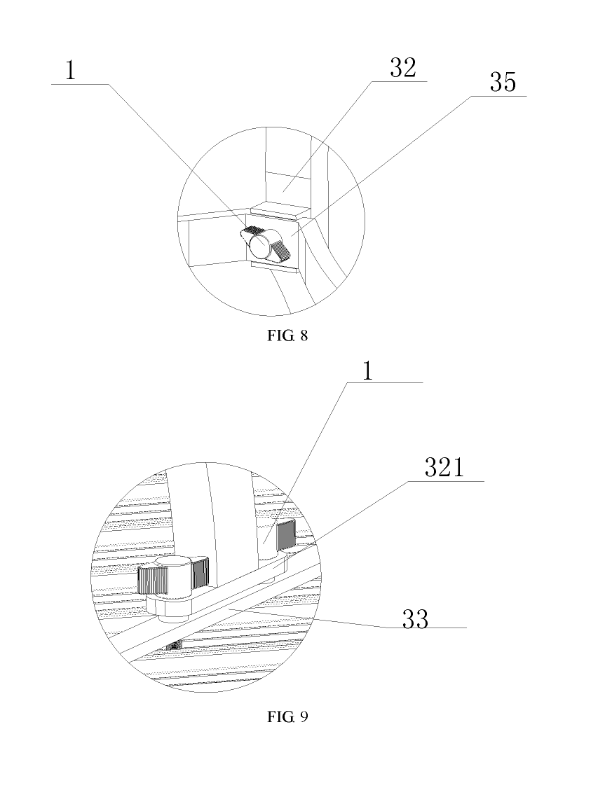

As shown in FIG. 9, the edge with the chamfer 35 of the fixing frame 34 serves as the first stopper, and the table leg 32 serves as the second stopper. The table legs 32 and the fixing frame are fixedly connected via the thumb screw 1 of the thumb screw connecting structure.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A thumb screw connecting structure, comprising: a thumb screw, a first stopper, and a second stopper, wherein the first stopper and the second stopper are fixedly connected via the thumb screw; and
wherein a protruding fixing portion is disposed at the second stopper, an internal thread fitting the thumb screw is disposed inside the protruding fixing portion, and the protruding fixing portion is used to fix the thumb screw.

2. The thumb screw connecting structure according to claim 1, wherein the thumb screw comprises a screw head and a screw section connected with the screw head, the screw head comprises a screw head main body and at least two screwing portions, and the screw head main body is fixedly connected with each screwing portions; and
wherein the screwing portion comprises a first connector and a second connector, a surface of the first connector and a surface of the second connector are provided with friction portions, respectively, the first connector is fixedly connected with the second connector, and the surface of the first connector and the surface of the second connector are smoothly connected and form an angle.

3. The thumb screw connecting structure according to claim 2, wherein the friction portions fully cover the surface of the first connector and the surface of the second connector, respectively.

4. The thumb screw connecting structure according to claim 2, wherein the screw head is a plastic screw head.

5. A chair, comprising a supporting frame, a left armrest, a right armrest, a backrest, a base plate and the thumb screw connecting structures as claimed in claim 1; and
wherein the base plate is connected with the supporting frame via a plurality of thumb screw connecting structures, the left armrest and the right armrest are located at two sides of the supporting frame, respectively, and the backrest is located between the left armrest and the right armrest and connected with the supporting frame.

6. A chair, comprising a supporting frame, a left armrest, a right armrest, a backrest, a base plate and thumb screw connecting structures of claim 2; and
wherein the base plate is connected with the supporting frame via a plurality of thumb screw connecting structures, the left armrest and the right armrest are located at two sides of the supporting frame, respectively, and the backrest is located between the left armrest and the right armrest and connected with the supporting frame.

7. A chair, comprising a supporting frame, a left armrest, a right armrest, a backrest, a base plate and the thumb screw connecting structures of claim 3; and
wherein the base plate is connected with the supporting frame via a plurality of thumb screw connecting structures, the left armrest and the right armrest are located at two sides of the supporting frame, respectively, and the backrest is located between the left armrest and the right armrest and connected with the supporting frame.

8. A chair, comprising a supporting frame, a left armrest, a right armrest, a backrest, a base plate and the thumb screw connecting structures of claim 4; and
wherein the base plate is connected with the supporting frame via a plurality of thumb screw connecting structures, the left armrest and the right armrest are located at two sides of the supporting frame, respectively, and the backrest is located between the left armrest and the right armrest and connected with the supporting frame.

9. The chair according to claim 5, wherein a first surrounding edge, a second surrounding edge and a third surrounding edge are disposed at the supporting frame, the first surrounding edge, the second surrounding edge and the third surrounding edge serve as the first stopper, respectively, the base plate and the edges corresponding to the first surrounding edge, the second surrounding edge and the third surrounding edge serve as the second stopper, and the base plate and the supporting frame are fixedly connected via the thumb screw of the thumb screw connecting structure.

10. The chair according to claim 6, wherein a first surrounding edge, a second surrounding edge and a third surrounding edge are disposed at the supporting frame, the first surrounding edge, the second surrounding edge and the third surrounding edge serve as the first stopper, respectively, the base plate and the edges corresponding to the first surrounding edge, the second surrounding edge and the third surrounding edge serve as the second stopper, and the base plate and the supporting frame are fixedly connected via the thumb screw of the thumb screw connecting structure.

11. The chair according to claim 7, wherein a first surrounding edge, a second surrounding edge and a third surrounding edge are disposed at the supporting frame, the first surrounding edge, the second surrounding edge and the third surrounding edge serve as the first stopper, respectively, the base plate and the edges corresponding to the first surrounding edge, the second surrounding edge and the third surrounding edge serve as the second stopper, and the base plate and the supporting frame are fixedly connected via the thumb screw of the thumb screw connecting structure.

12. A table, comprising a table top, table legs and the thumb screw connecting structures of claim 1; and
wherein supporting portions with a number corresponding to the table legs are disposed below the table top, and the supporting portions and the table legs are fixed via a plurality of thumb screw connecting structures.

13. A table, comprising a table top, table legs and the thumb screw connecting structures of claim 2; and
wherein supporting portions with a number corresponding to the table legs are disposed below the table top, and the supporting portions and the table legs are fixed via a plurality of thumb screw connecting structures.

14. A table, comprising a table top, table legs and thumb screw connecting structures of claim 3; and
wherein supporting portions with a number corresponding to the table legs are disposed below the table top, and the supporting portions and the table legs are fixed via a plurality of thumb screw connecting structures.

15. A table, comprising a table top, table legs and the thumb screw connecting structures of claim 4; and
wherein supporting portions with a number corresponding to the table legs are disposed below the table top, and the supporting portions and the table legs are fixed via a plurality of thumb screw connecting structures.

16. The table according to claim 12, further comprising fixing frames, wherein the number of edges of the fixing frames is equal to the number of the table legs; and
wherein a chamfer is disposed at a joint of two edges of the fixing frame, and an edge with the chamfer and the table leg are fixed via a plurality of thumb screw connecting structures.

17. The table according to claim 12, wherein the supporting portion serves as the second stopper, a beam is disposed at a top of the table leg, the beam serves as the first stopper, and the table top and the table legs are fixed via the thumb screws of the thumb screw connecting structures.

18. The table according to claim 12, wherein the edge of the fixing frame with the chamfer serves as the first stopper, the table legs serve as the second stopper, and the table legs and the fixing frame are fixedly connected via the thumb screws of the thumb screw connecting structures.
